(19) United States
(12) Patent Application Publication
(10) Pub. No.: US 2014/0099609 A1
(43) Pub. Date: Apr. 10, 2014

(54) READING SYSTEM

(71) Applicant: Horacio LeDon, New York, NY (US)

(72) Inventor: Horacio LeDon, New York, NY (US)

(21) Appl. No.: 14/046,774

(22) Filed: Oct. 4, 2013

Related U.S. Application Data
(60) Provisional application No. 61/709,835, filed on Oct. 4, 2012.

(51) Int. Cl. G09B 17/00

(52) U.S. Cl. CPC G09B 17/003
USPC 434/178

(57) ABSTRACT

A system including a data storage device connected to a server. The device stores identifiers associated with sounds in a selected language. As a result of advertising, the identifiers (e.g., logos) are well known to an audience including users. Each sound associated with one of the identifiers is included in a brand name also associated with the identifier. The server is connected to client computing devices operated by the users. The server receives a different lesson request from each the client computing devices, and in response to each lesson request, selects one of the sounds as a selected sound, and instructs the client computing device from which the lesson request was received to display a display. The display includes at least one of the identifiers associated with the selected sound, and one or more letters spelling the selected sound, and/or a vocabulary word that includes the selected sound.

### CROSS REFERENCE TO RELATED APPLICATION(S)

This application claims the benefit of U.S. Provisional Application No. 61/709,835, filed Oct. 4, 2012, which is incorporated herein by reference in its entirety.

### BACKGROUND OF THE INVENTION

1. Field of the Invention

The present invention is directed generally to reading systems, and more particularly, to reading systems that utilize students' recognition of popular brands to teach students how to read similar words and phrases

2. Description of the Related Art

The following description includes information that may be useful in understanding the present invention. It is not an admission that any of the information provided herein is prior art or relevant to the presently claimed invention, or that any publication specifically or implicitly referenced is prior art.

Literacy refers to the ability to read for knowledge, write coherently, and think critically about the written word. Literacy represents a lifelong, intellectual process of gaining meaning from a critical interpretation of written or printed text. A key to literacy is reading development, a progression of skills that begins with the ability to understand spoken words and decode written words, and culminates in the deep understanding of text. Reading development involves a range of complex language underpinnings including awareness of speech sounds (phonology), spelling patterns (orthography), word meaning (semantics), grammar (syntax), and patterns of word formation (morphology), all of which provide a necessary platform for reading fluency and comprehension.

Therefore, a need exists for methods and systems that help users learn how to read. The present application provides these and other advantages as will be apparent from the following detailed description and accompanying figures.

### SUMMARY OF THE INVENTION

Embodiments include methods and systems implementing a reading system and/or reading methodology configured to help users learn how to read. A first embodiment includes a first computer implemented method for use with a client computing device operated by a user. The client computing device is connected to a server computing device by at least one network. The server computing device is connected to or includes a data storage device. The method includes associating, in the data storage device, an identifier of a brand or product with a particular sound in a selected language. The identifier may be a trademark or a logo. The brand or product has a name including the particular sound in the selected language. The identifier was promoted to an audience that includes the user by a sponsor entity associated with the brand or product. The audience may include the general public. The identifier is well known to the audience as a result of the promotion. The method also includes receiving, by the server computing device, a request for a lesson from the client computing device. The lesson is configured to help teach the user to read one or more letters spelling at least one of (a) the particular sound in the selected language, and (b) a word including the particular sound in the selected language. In response to the request, the method includes transmitting, by the server computing device, instructions configured to instruct the client computing device to display a display to the user, and recording completion of the lesson. The display includes (a) the one or more letters, and (b) the identifier of the brand or product. Optionally, the display may include at least one of (a) an audio file, and (b) a link to the audio file. When the audio file is played back, the audio file pronounces the particular sound.

The server computing device may be operated by a teaching entity that is different from the sponsor entity. The teaching entity may receive at least one payment from the sponsor entity in exchange for associating the identifier with the particular sound in the data storage device. The teaching entity may charge the sponsor entity an amount of money for transmitting the display. The server computing device may send an invoice to the sponsor entity. The invoice may include a fee based at least in part on the display having been transmitted.

The sponsor entity may operate a sponsor computing system connected to the server computing device. The server computer device may transmit a request to the sponsor computing system requesting that a reward be sent to the user operating the client computing device. The reward may be associated with the identifier of the brand or product.

A second embodiment includes a second computer implemented method for use with a client computing device operated by a user. The client computing device is connected to a server computing device by at least one network. The server computing device is connected to or includes a data storage device. The second method includes associating, in the data storage device, a plurality of identifiers with a plurality of sounds in a selected language. The plurality of identifiers are well known to an audience including the user as a result of advertising. The audience may include the general public. Each of the plurality of identifiers is associated with a brand name, and each sound associated with one of the identifiers is included in the brand name also associated with the identifier. The second method also includes selecting, by the server computing device, one of the plurality of sounds, and transmitting, by the server computing device, instructions configured to instruct the client computing device to display a display to the user. The display includes (a) one or more letters spelling the selected sound in the selected language, and (b) at least one of the identifiers associated with the selected sound.

The display may be a first display. The second method may further include selecting, by the server computing device, a vocabulary word including the selected sound, and transmitting, by the server computing device, instructions configured to instruct the client computing device to display a second display to the user. The second display including (a) one or more letters spelling the vocabulary word, and (b) at least one of the identifiers associated with the second selected sound.

Further, the selected sound may be a first selected sound. The second method may further include selecting, by the server computing device, one of the plurality of sounds as a second selected sound, and transmitting, by the server computing device, instructions configured to instruct the client computing device to display a second display to the user. The second display may include (a) one or more letters spelling the second selected sound in the selected language, and (b) at least one of the identifiers associated with the second selected sound. Alternatively, the second display may include (a) one or more letters spelling a vocabulary word in the selected language that includes the second selected sound, and (b) at least one of the identifiers associated with the second selected sound. The second selected sound may be different from the first selected sound.

Each of the plurality of identifiers may be associated with a sponsorship level, and the second method may include selecting, by the server computing device, the at least one of the identifiers associated with the selected sound based at least in part on the sponsorship level associated with each of the identifiers associated with the selected sound.

Each of the plurality of identifiers may be associated with first demographic information, and the second method may include associating, in the data storage device, the user with second demographic information, and selecting, by the server computing device, the at least one of the identifiers associated with the selected sound based at least in part on the second demographic information and the first demographic information associated with each of the identifiers associated with the selected sound.

The second method may include associating, in the data storage device, each of the plurality of identifiers with a sponsorship level, and selecting, by the server computing device, the at least one of the identifiers associated with the selected sound based at least in part on the sponsorship level associated with each of the identifiers associated with the selected sound.

A third embodiment includes a system for use with a plurality of client computing devices operated by a plurality of users. The system includes a data storage device, and a server computing device connected to both the data storage device, and the plurality of client computing devices. The data storage device stores a plurality of identifiers associated with a plurality of sounds in a selected language. The plurality of identifiers are well known to an audience including the plurality of users as a result of advertising. Each of the plurality of identifiers is associated with a brand name, and each sound associated with one of the identifiers is included in the brand name also associated with the identifier. the server computing device is configured to execute computer executable instructions that when executed perform a method. The method includes receiving a plurality of lesson requests. A different lesson request is received from each the plurality of client computing devices. In response to each of the plurality of lesson requests, the method also includes selecting one of the plurality of sounds as a selected sound, and transmitting a display to the client computing device from which the lesson request was received. The display includes at least one of the identifiers associated with the selected sound, and one or more letters spelling at least one of (a) the selected sound in the selected language, and (b) a vocabulary word in the selected language that includes the selected sound.

The system may be for use with a sponsor computing system connected to the server computing device. The sponsor computing system is operated by a sponsor entity, and each of at least a portion of the plurality of identifiers is associated with the sponsor entity in the data storage device. Each identifier associated with the sponsor entity is a sponsored identifier. For a particular one of the lesson requests, the at least one of the identifiers associated with the selected sound includes at least one sponsored identifier. Optionally, the method further includes transmitting usage information to the sponsor computing system. The usage information indicates that the display including the at least one sponsored identifier was transmitted. Optionally, the method further includes transmitting an invoice to the sponsor computing system. The invoice includes a fee based at least in part on the display including the at least one sponsored identifier having been transmitted. The plurality of identifiers may be associated with a plurality of sponsor entities in the data storage device, and the method may further include periodically sending invoices to the plurality of sponsor entities, and receiving payments from the plurality of sponsor entities in response to the invoices.

Each of the plurality of identifiers may be associated with a sponsorship level in the data storage device, and the method may further include, in response to each of the plurality of lesson requests, selecting the at least one of the identifiers associated with the selected sound included in the display based at least in part on the sponsorship level associated with each of the plurality of identifiers associated with the selected sound.

Each of the plurality of users may be associated with first demographic information, and each of the plurality of identifiers may be associated with second demographic information in the data storage device. The method may further include, in response to each of the plurality of lesson requests, selecting the at least one of the identifiers associated with the selected sound included in the display based at least in part on (a) the second demographic information associated with each of the plurality of identifiers associated with the selected sound, and (b) the first demographic information associated with the user of the client computing device from which the lesson request was received.

### BRIEF DESCRIPTION OF THE SEVERAL VIEWS OF THE DRAWING(S)

FIG. 1 is a diagram of a system configured to implement a brand-based reading system or teaching methodology.

FIG. 2 is a block diagram illustrating exemplary information that may be stored in a data storage device of the system of FIG. 1.

FIG. 3 is a block diagram illustrating a first portion of exemplary data that may be stored in the data storage device of the system of FIG. 1.

FIG. 4 is a block diagram illustrating a second portion of exemplary data that may be stored in the data storage device of the system of FIG. 1.

FIG. 5 is a first exemplary display generated by a server computing device and transmitted to a client computing device for display thereby.

FIG. 6 is a second exemplary display generated by the server computing device and transmitted to the client computing device for display thereby.

FIG. 7 is a third exemplary display generated by the server computing device and transmitted to the client computing device for display thereby.

FIG. 8 is a fourth exemplary display generated by the server computing device and transmitted to the client computing device for display thereby.

FIG. 9 is a fifth exemplary display generated by the server computing device and transmitted to the client computing device for display thereby.

FIG. 10 is a flow diagram of a first method performed by the server computing device.

FIG. 11 is a flow diagram of a second method performed by the server computing device.

FIG. 12 is an exemplary sponsorship user interface generated by the server computing device and transmitted to a sponsor computing system for display thereby.

FIG. 13 is a diagram of hardware and an operating environment in conjunction with which implementations of the computing devices and network of the system of FIG. 1 may be practiced.

### DETAILED DESCRIPTION OF THE INVENTION

One skilled in the art will recognize many methods, systems, and materials similar or equivalent to those described herein, which could be used in the practice of the present invention. Indeed, the present invention is in no way limited to the methods, systems, and materials described.

### Overview

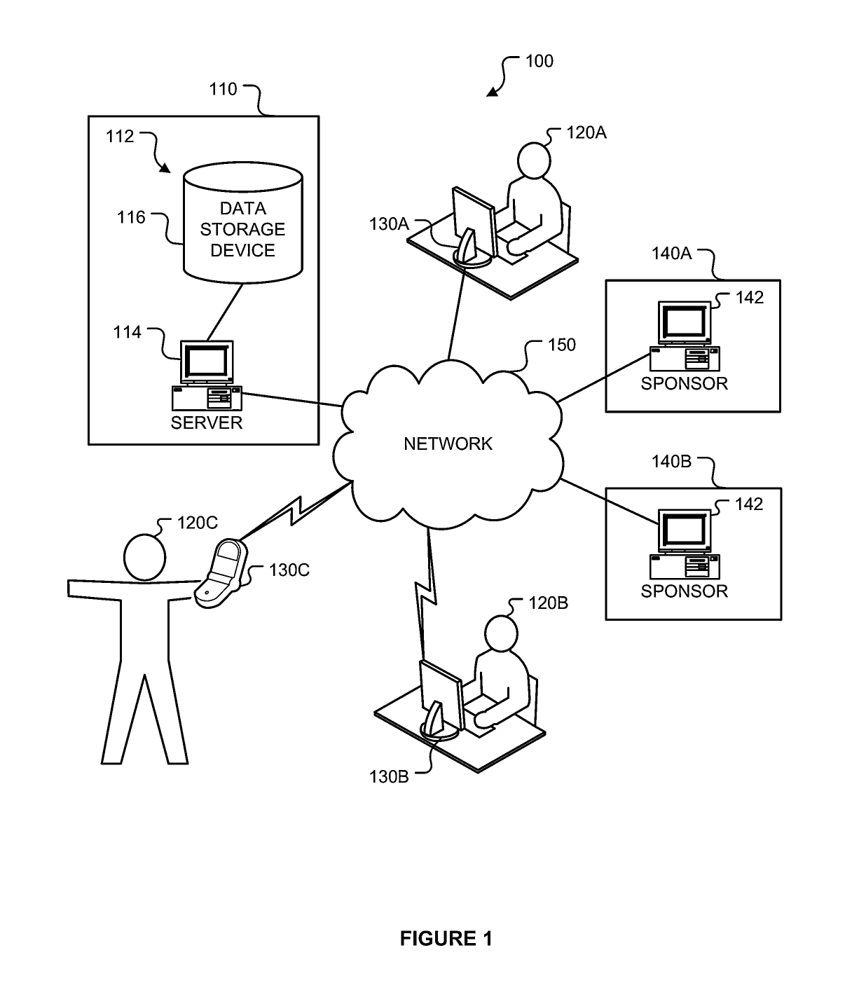

FIG. 1 is block diagram of a system 100. The system 100 includes a computing system 112 operated by a teaching entity 110. The computing system 112 is configured to implement a brand-based reading system or teaching methodology. The computing system 112 provides brand-based reading lessons to a plurality of users 120A-120C each operating at least one client computing device. In the example illustrated, the users 120A-120C operate client computing devices 130A-130C, respectively. While the three users 120A-120C are illustrated in FIG. 1, those of ordinary skill in the art appreciate that the system 100 may include any number of users.

The computing system 112 includes at least one server 114 configured to communicate with the client computing devices 130A-130C. The server 114 is connected to a data storage device 116 configured to store information used by other components (e.g., the server 114) of the computing system 112. The data storage device 116 may be component of the server 114 or a separate device connected thereto. In the embodiment illustrated, the data storage device 116 is illustrated implementing a database. However, this is not a requirement.

The server 114 is configured to execute computer executable instructions that may be stored in the data storage device 116, local memory, and/or a separate data storage device. When executed, the computer executable instructions implement a brand-based reading system described below. The server 114 may include conventional web server components configured to generate and transmit web pages to the client computing devices 130A-130C operated by the users 120A-120C. In such embodiments, each of the client computing devices 130A-130C may include a conventional internet browser application configured to display the web pages transmitted by the server 114.

The system 100 includes a plurality of sponsor entities 140A and 140B that each operates a sponsor computing system 142. Each of the sponsor entities 140A and 140B promotes at least one brand/product identifier (e.g., trademark, logo, brand name, etc.) associated with at least one brand name and/or product to an audience. As a result of these promotional activities, the brand/product identifiers are well known to the audience (which may be the general public, a national audience, a demographic within a national audience, and the like). Further, at least some of the brand/product identifiers may be famous. The users 120A-120C are members of the audience and therefore, familiar with the brand/product identifiers. While the two sponsor entities 140A and 140B are illustrated in FIG. 1, those of ordinary skill in the art appreciate that the system 100 may include any number of sponsor entities.

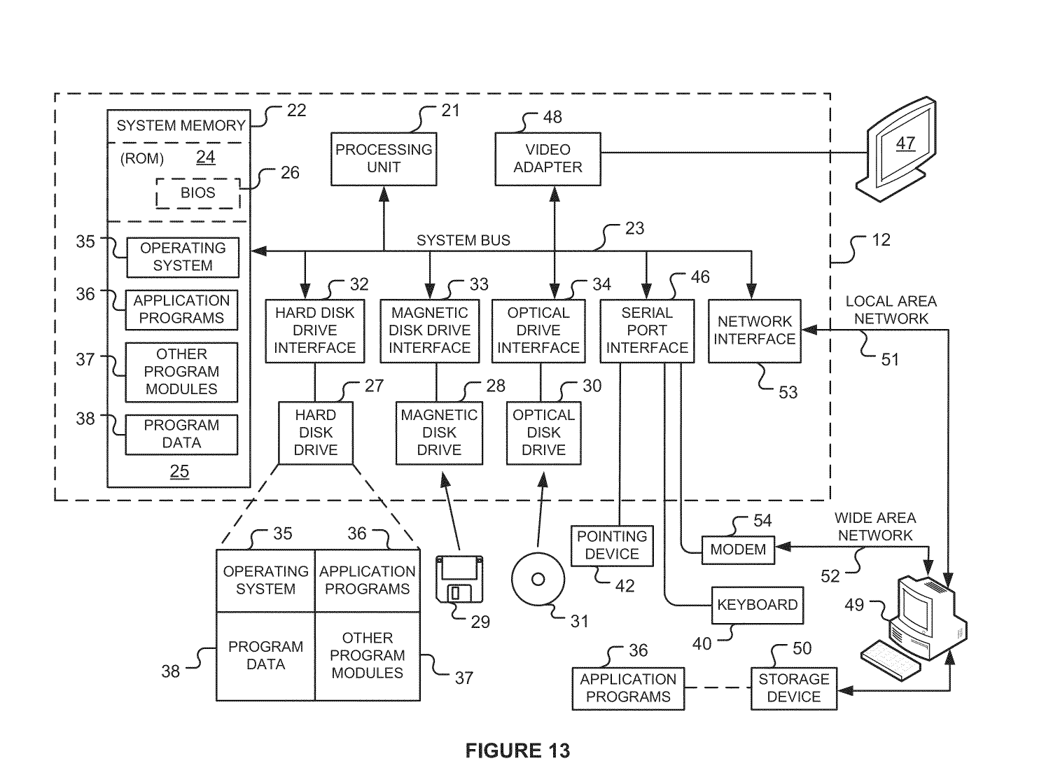

In the system 100, the computing system 112, the client computing devices 130A-130C, and sponsor computing systems 142 are connected to one another by a network 150 (e.g., the Internet). Each of the client computing devices 130A-130C may be implemented using a computing device 12 illustrated in FIG. 13 and described below. Further, the computing system 112, and sponsor computing systems 142 may each be implemented by one or more computing devices like the computing device 12. For example, the server 114 may be implemented by one or more computing devices like the computing device 12.

As mentioned above, the computing system 112 implements a brand-based reading system configured to teach the users 120A-120C (e.g., students) to read a selected language (e.g., English, or other language). For example, the computing system 112 may be configured to provide a free, brand name-associated curriculum of more than 6,500 English words organized into a 12-week course to the users 120A-120C. Other formats may also be provided. Further, the selected language may include native tongues other than English.

Children and adults who are unable to read can often nevertheless read and identify popular brands and products to which they had been exposed through advertising. The computing system 112 leverages this fact to teach the users 120A-120C to read words that are similar to brand and/or product names. For example, if the user 120A can read and identify the brand name COKED, the user 120A could presumably also read the words “joke,” “poke,” and other similarly sounding words. Similarly, if the user 120A can read and identify the popular laundry detergent associated with the brand name TIDED, the user 120A should also be able to do the same for the words “ride,” “side,” etc.

The computing system 112 may also be used to teach the users 120A-120C to read multi-syllable words that use similarly constructed words as either a prefix or a suffix. For example, if the user 120B knows the first syllable of the brand name PEPSI® sounds like “pep,” and the user 120B knows the brand name TIDED, the computing system 112 may teach the user 120B to read the word “peptide” by concatenating “pep” and “tide.” By way of a non-limiting example, brand/product identifiers (e.g., logos) associated with the brand names PEPSI® and TIDE® may be displayed to the user 120B along with the word “peptide” so that the user can make the appropriate association.

The computing system 112 may associate each and every sound in the English language (and/or other languages) or a portion thereof with one or more brand/product identifiers. This type of association may be used as a basis for a fun to use reading system that allows for greater concentration through brand association and thus greater learning for the users 120A-120C.

### Data Storage Device

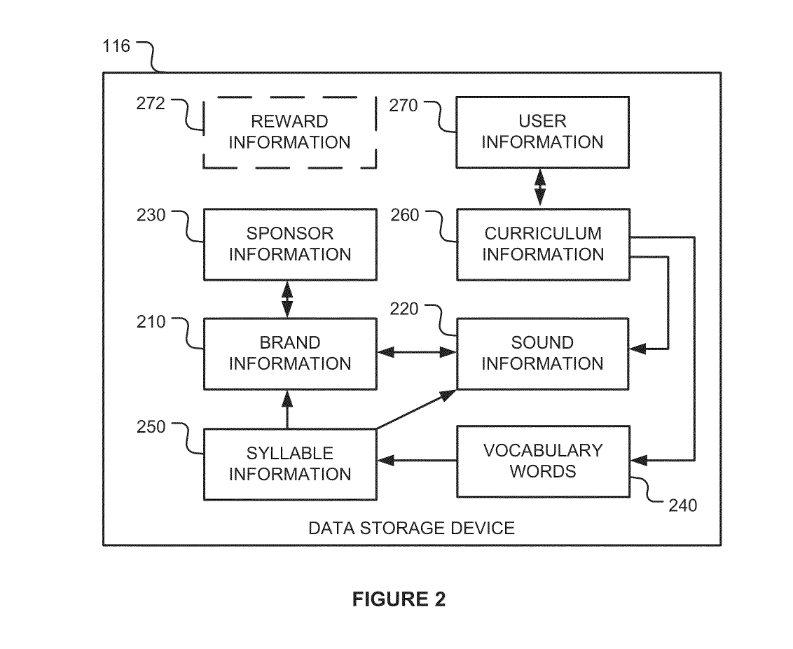

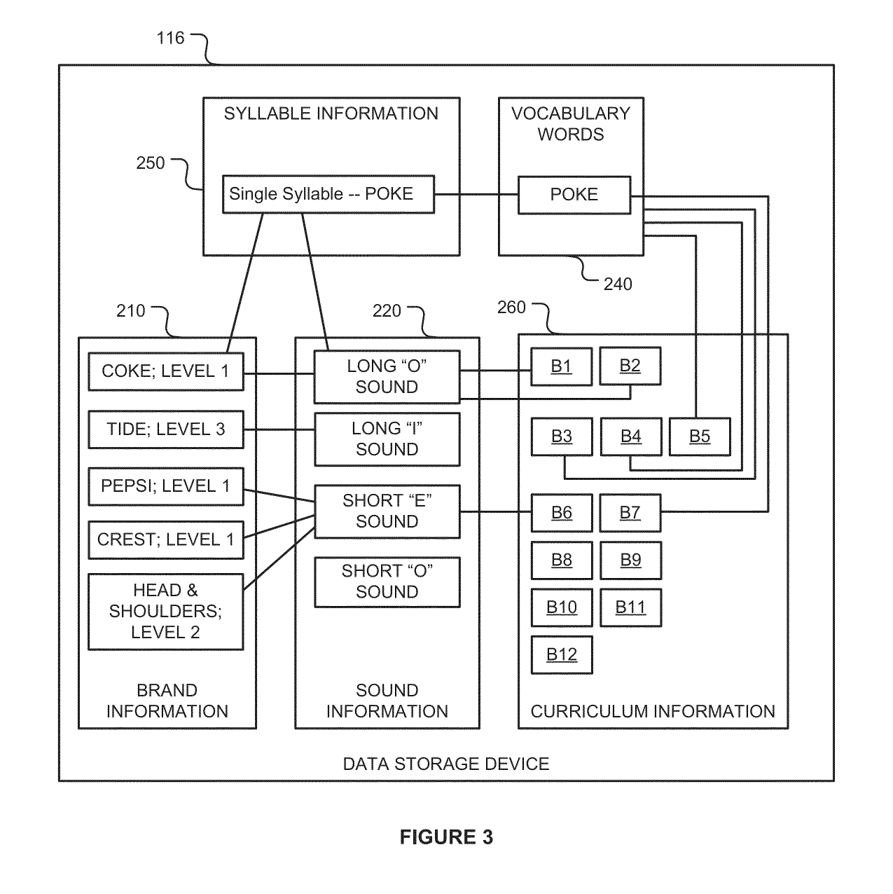

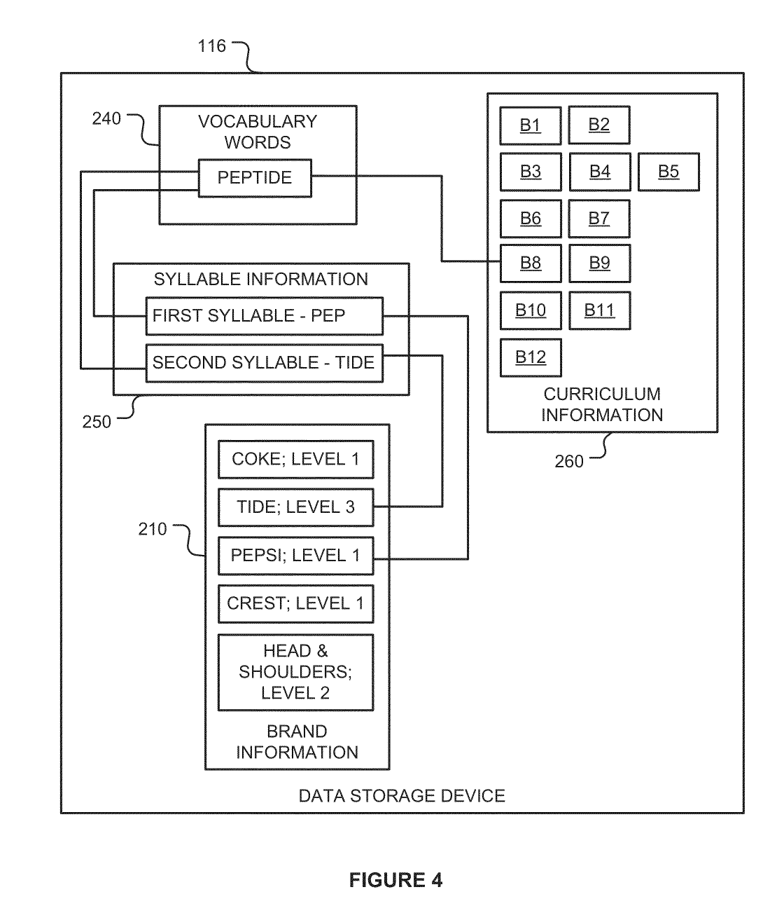

FIG. 2 is a block diagram illustrating exemplary information that may be stored by the data storage device 116. The data storage device 116 stores brand information 210, sound information 220, sponsor information 230, vocabulary words 240, syllable information 250, curriculum information 260, user information 270, and optional reward information 272. FIGS. 3 and 4 illustrate exemplary data that may be stored in the brand information 210, the sound information 220, the vocabulary words 240, the syllable information 250, and curriculum information 260.

Referring to FIG. 2, the brand information 210 stores brand/product identifiers for a plurality of brands and/or products. The brand information 210 may store information about brands and/or products (e.g., product types). For each brand/product identifier, the brand information 210 may store text spelling a brand name associated with the brand/product identifier. Optionally, in the brand information 210, each of the brand/product identifiers may be associated with user demographic information (e.g., geographic region, gender, age, ethnicity, nationality, religion, language, education, income, preferences, and the like) indicating which types of users are more likely to purchase products or services associated with the brand/product identifier. This information may be used to help select brand/product identifiers based on the demographics of the users 120A-120C. As will be explained below, the brand information 210 also stores a level of sponsorship associated with each brand/product identifier.

Turning to FIG. 2, the sound information 220 identifies a plurality of sounds in the selected language (e.g., English). Each brand/product identifier stored in the brand information 210 is associated with one or more sounds in the sound information 220. For each sound, the sound information 220 many include an audio file (and/or a link to an audio file) that when played back pronounces the sound. Further, for each sound, the sound information 220 includes one or more letters that spell the sound.

The sponsor information 230 identifies the sponsor entity associated with each brand/product identifier. Thus, the sponsor information 230 stores information identifying the sponsor entities 140A and 1408 (see FIG. 1), and links to the brand/product identifier(s) associated with each of the sponsor entities 140A and 140B.

The vocabulary words 240 store a plurality of vocabulary words in the selected language (e.g., English). Each of the vocabulary words 240 has at least one syllable stored in the syllable information 250. Each syllable is associated with a sound in the sound information 220, and at least one brand/product identifier stored in the brand information 210.

Table A below provides examples of single syllable vocabulary words (stored in the vocabulary words 240), their associated sounds stored in the sound information 220, and their associated brand/product identifiers stored in the brand information 210. In Table A, the brand/product identifiers listed are brand names. Alternatively, images (e.g., trademarks, logos, and the like) may be used as the brand/product identifiers.

TABLE A

| | | Single Syllable vocabulary |
|---|---|---|
| Identifier stored | Sound stored | words stored in the vocabulary |
| in the brand | in the sound | words 240 associated with the |
| information 210 | information 220 | identifier and the sound |
| COKE ® | Long “O” sound | Joke |
| | | Poke |
| | | Bloke |
| | | Stoke |
| TIDE ® | Long “I” sound | Ride |
| | | Glide |
| | | Tide |
| | | Slide |
| | | Hide |
| PEPSI ® | Short “E” sound | Step |
| | | Pep |
| | | Rep |
| | | Prep |
| | | Schlep |
| CREST ® | Short “E” sound | Best |
| | | Zest |
| | | Crest |
| | | Jest |
| | | Test |
| HEAD AND | Short “E” sound | Bread |
| SHOULDERS ® | | Spread |
| | | Head |
| | | Dread |
| | | Thread |
| SHOUT ® | “OU” sound | Shout |
| | | Out |
| | | Rout |
| | | Clout |
| | | Stout |
| | | Route |
| | | Pout |
| | | Sprout |
| | | Bout |
| FOX ® | Short “O” sound | Fox |
| | | Box |
| | | Lox |
| | | Vox |

Table B below provides examples of multiple syllable vocabulary words (stored in the vocabulary words 240) and their associated sounds stored in the sound information 220, and brand/product identifiers stored in the brand information 210. In Table B, the brand/product identifiers listed are brand names. Alternatively, images (e.g., trademarks, logos, and the like) may be used as the brand/product identifiers.

TABLE B

| | | Multiple Syllable |
|---|---|---|
| | | vocabulary words |
| | | stored in the |
| Identifiers stored | Sounds stored | vocabulary words 240 |
| in the brand | in the sound | associated with the |
| information 210 | information 220 | identifier and sound |
| PEPSI ® and TIDE ® | Short “E” sound and | Peptide |
| | Long “I” sound | |
| SHOUT ® and FOX ® | “OU” sound and | Outfox |
| | Short “O” sound | |

As will be explained below, the curriculum information 260 implements a curriculum that includes a plurality of lessons. The curriculum information 260 is linked to the sound information 220, the vocabulary words 240, and the user information 270.

The user information 270 stores information about the users 120A-120C. For example, the user information 270 may store demographic information about each of the users 120A-120C (e.g., address, gender, age, ethnicity, nationality, religion, language, education, income, preferences, and the like). The user information 270 may identify which lesson(s) in the curriculum each of the users 120A-120C has requested (and/or completed). The user information 270 may also store which tangible reward(s), if any, each of the users 120A-120C has received. In some embodiments, the users 120A-120C may pay a fee to receive the lessons. In such embodiments, the user information 270 may store payment information, and/or a record that the fee has been received. In some embodiments, all or a portion of the fee may be refunded to those users that complete the curriculum. In some embodiments, a portion of the fee may be refunded after each of the books B1-B12 is completed. In such embodiments, the user information 270 may store information indicating how much of the fee has been refunded and/or how much of the fee has been retained by the teaching entity 110.

The optional reward information 272 specifies which (if any) rewards are given to the users 120A-120C, when the rewards are given, and provides information necessary to award or otherwise effect the rewards.

### Example Curriculum

As mentioned above, the curriculum information 260 implements a curriculum that includes a plurality of lessons. The following is a non-limiting example of a curriculum that may be implemented by the curriculum information 260. Referring to FIGS. 3 and 4, the lessons may be are organized into 12 sets of lessons (referred to as books B1-B12), one for each week in an exemplary 12-week course. Each of the books B1-B12 may include one or more lessons.

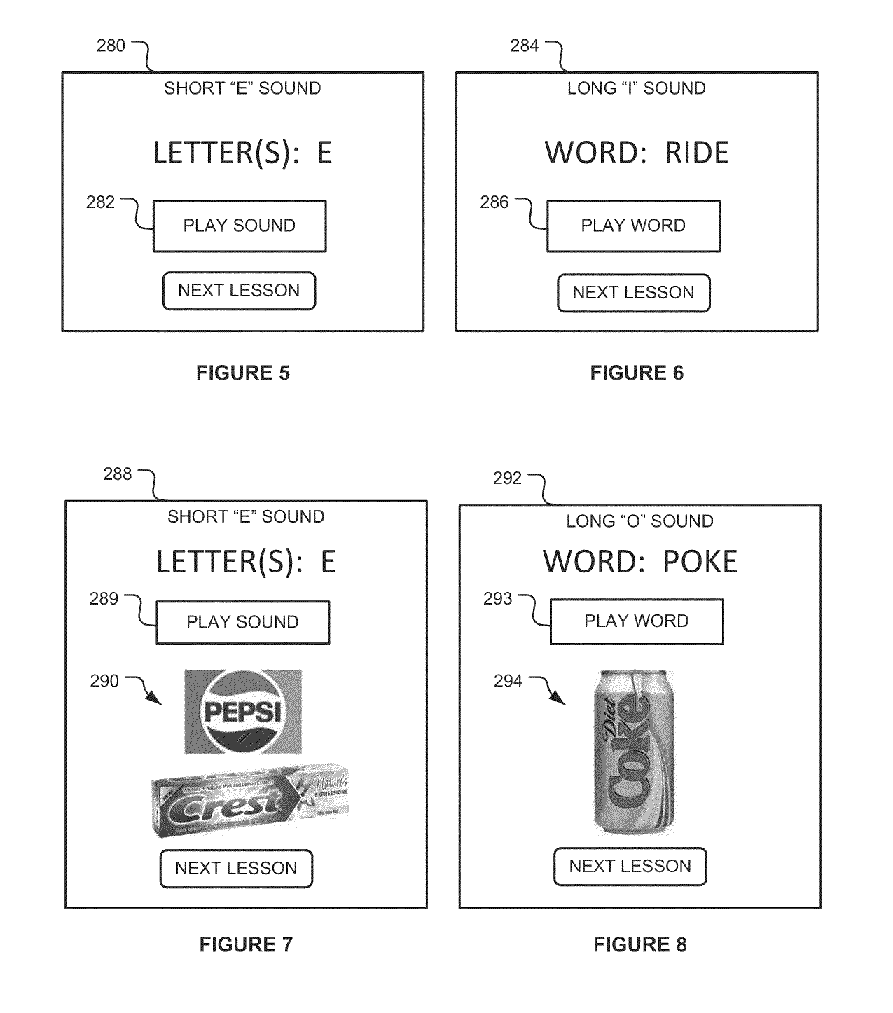

Within each lesson, at least one of the sounds stored in the sound information 220 is presented to one of the users 120A-120C (see FIG. 1). For example, referring to FIG. 3, the first two books B1 and B2 may teach the users 120A-120C how to pronounce and spell vowel sounds. Thus, the books B1 and B2 are linked to the sound information 220. Using these books, the users 120A-120C learn how to pronounce a vowel letter depending upon its position in the structure of the syllables:
(1) one or two vowel letters,
(2) one, two, or three consonant letters after the vowel,
(3) no consonant sound after the vowel, or
(4) a vowel letter also after the consonant sound.
   For example, the books B1 and B2 may identify each unique vowel sound in the sound information 220. Then, referring to FIG. 5, for each sound, the server 114 generates a display 280 (e.g., a webpage) configured to be displayed by the client computing devices 130A-130C. The display 280 includes the letter(s) that produce the sound (e.g., the letter “E”), and an audio file (and/or a link 282 to an audio file) that when played back generates the sound. Optionally, the display 280 may include a button “NEXT LESSON” that when activated, indicates the user has completed the lesson displayed by the display 280, and wishes to receive the next lesson.

Referring to FIG. 3, the third, fourth, and fifth books B3-B5 include one-syllable words arranged in a specific linguistic order:
words beginning and ending with a single consonant sound (e.g., pop);
words beginning with multiple consonant sounds (e.g., chair); and
words ending in multiple consonant sounds (e.g., chuck).
   Thus, the books B3-B5 are linked to the vocabulary words 240. By way of a non-limiting example, the books B3-B5 may include (or be linked to) about 6,000 one-syllable words.

For example, the third book B3 may identify those of the vocabulary words 240 that have a single syllable, and begin and end with a single consonant sound. For example, the third book B3 may identify the word “RIDE.” Then, referring to FIG. 6, the server 114 generates a display 284 configured to be displayed by the client computing devices 130A-130C. The display 284 includes the word, and an audio file (and/or a link 286 to an audio file) that when played back pronounces the word. Optionally, the display 284 may include a button “NEXT LESSON” that when activated, indicates the user has completed the lesson displayed by the display 284, and wishes to receive the next lesson.

At this stage, the users 120A-120C are able to apply the linguistic concepts learned about the pronunciation and spelling of the vowel sounds, and deduce syllabic structures found in some words.

Returning to FIG. 3, the next four books, the sixth book B6 through the ninth book B9 in the series, use brand names to reinforce the learning of the concepts taught in each lesson. These books may also introduce (e.g., later on) multi-syllable concepts, using brand names as examples. Some non-limiting examples of brand names and associated words are provided in Tables A and B above.

By way of a non-limiting example, the sixth book B6 may identify the short “E” sound, which in the example illustrated in FIG. 3 is linked to three brand/product identifiers: PEPSI®, CREST®, and HEAD & SHOULDERS®. The server 114 (see FIG. 1) selects one or more of these brand/product identifiers associated with the selected sound. As will be described below, this selection may be based at least in part on level of sponsorship associated with the brand/product identifier(s) in the brand information 210. For example, in FIG. 3, the brand names PEPSI® and CREST® are associated with the same “LEVEL 1” of sponsorship in the brand information 210. In this example, the brand name HEAD & SHOULDERS® is associated with the “LEVEL 2” of sponsorship, which is a lower level of sponsorship than the “LEVEL 1.” Thus, the server 114 selects the brand names PEPSI® and CREST®.

By way of another non-limiting example, the brand/product identifier(s) associated with the selected sound may be selected based at least in part on the demographic information associated with the user stored in the user information 270 (see FIG. 2). For example, if the user is a female, the server 114 may select one or more brand/product identifiers associated in the brand information 210 with the female gender.

Then, referring to FIG. 7, the server 114 generates a display 288 configured to be displayed by the client computing devices 130A-130C. The display 288 includes the letter(s) that produce the sound (e.g., the letter “E”), and an audio file (and/or a link 289 to an audio file) that when played back generates the sound, and the selected brand/product identifier(s) 290 to be used as exemplary familiar word(s) that include the sound. In the embodiment illustrated, the brand/product identifiers 290 are images. Optionally, the display 288 may include a button “NEXT LESSON” that when activated, indicates the user has completed the lesson displayed by the display 288, and wishes to receive the next lesson.

By way of another non-limiting example, the seventh book B7 may identify those of the vocabulary words that have a single syllable. For example, the book B7 may identify the word “POKE.” The server 114 (see FIG. 1) selects one or more of these brand/product identifiers associated with the sound (e.g., long “O” sound) that is associated with the selected word. As will be described below, this selection may be based at least in part on level of sponsorship associated with the brand/product identifier(s) in the brand information 210. By way of another non-limiting example, the brand/product identifier(s) may be selected based at least in part on the demographic information associated with the user stored in the user information 270 (see FIG. 2). For example, if the user is a consumer of soft drinks, the server 114 may select one or more brand/product identifiers associated in the brand information 210 with soft drinks.

Then, referring to FIG. 8, the server 114 generates a display 292 to be displayed by the computing device 130A. The display 292 includes the selected word (e.g., “POKE”), an audio file (and/or a link 293 to an audio file) that when played back plays the word, and the brand/product identifier(s) 294 (e.g., the brand name COKE®) associated with the vocabulary word to be used as a hint or aid in pronouncing the word. In the embodiment illustrated, the brand/product identifier 294 is an image. Optionally, the display 292 may include a button “NEXT LESSON” that when activated, indicates the user has completed the lesson displayed by the display 292, and wishes to receive the next lesson.

By way of another non-limiting example, referring to FIG. 4, the eighth book B8 may identify those of the vocabulary words 240 that have two or more syllables, each associated with a brand/product identifier in the brand information 210. For example, the book B8 may identify the two-syllable word “peptide.” The first syllable “pep” is associated with the brand name PEPSI®, and the second syllable “tide” is associated with the brand name TIDE®. If one or more of the syllables is associated with more than one brand/product identifier, the server 114 selects one or more of those brand/product identifiers. As will be described below, this selection may be based at least in part on level of sponsorship associated with the brand/product identifier(s) in the brand information 210. By way of another non-limiting example, the brand/product identifier(s) may be selected based at least in part on the demographic information associated with the user stored in the user information 270 (see FIG. 2). For example, if the user is six-years old, the server 114 may select one or more brand/product identifiers associated in the brand information 210 with ages 5-10.

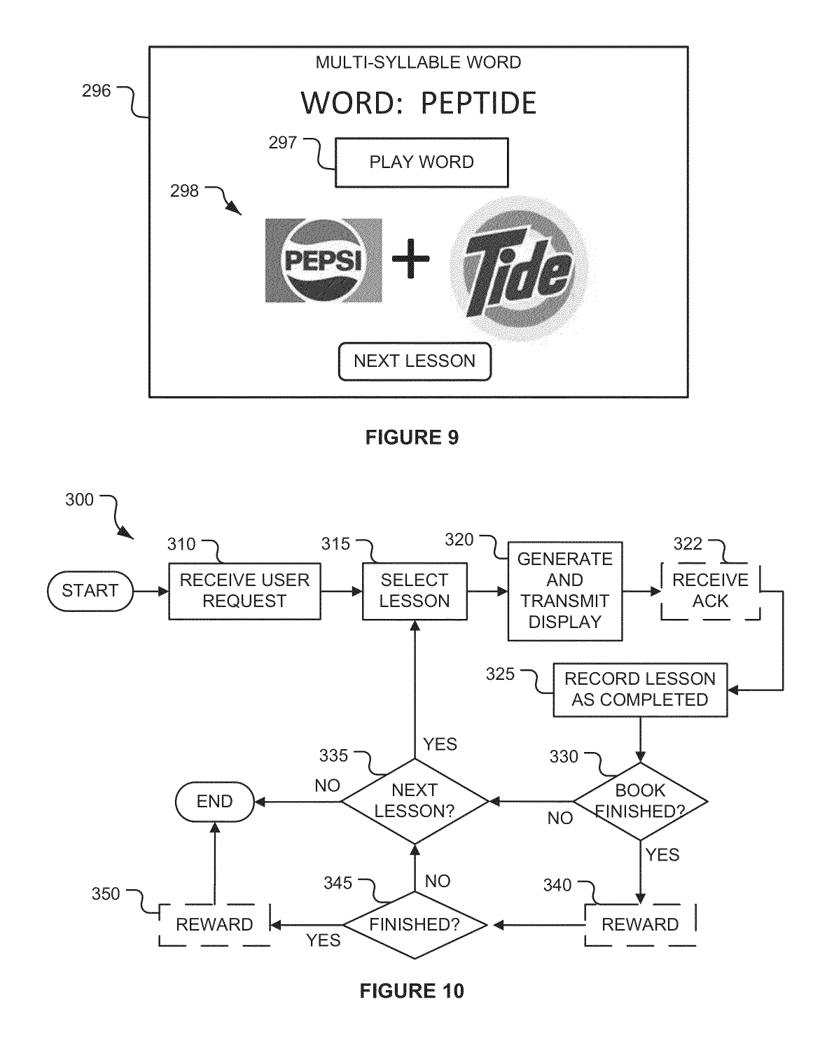

Then, referring to FIG. 9, the server 114 generates a display 296 configured to be displayed by the client computing devices 130A-130C. The display 296 includes the word, an audio file (and/or a link 297 to an audio file) that when played back pronounces the word, and the selected brand/product identifier(s) 298 associated with each syllable of the word to be used as a hint or aid in pronouncing the word. In the embodiment illustrated, the brand/product identifiers 298 are images. Optionally, the display 296 may include a button “NEXT LESSON” that when activated, indicates the user has completed the lesson displayed by the display 296, and wishes to receive the next lesson.

The tenth book B10 and eleventh book B11 may review linguistic concepts taught previously in earlier books. The final twelfth book B12 includes all of the one-syllable words used in the reading system but with a different arrangement. Specifically the final book B12 includes a list of words written with the letter or letters a, e, i, o, u, ea, oa, ae, oe, ue, ai, ei, oi, ay, ey, oy, oo, au, eu, ou, aw, ew, ow, igh, eigh, ough, etc. The final book B12 also includes a list of those of the vocabulary words 240 associated with each of the different vowel sound combinations.

### The Business Model

As mentioned above, referring to FIG. 2, each brand/product identifier stored in the brand information 210 is associated with a sponsorship level and one of the sponsor entities 140A and 140B (see FIG. 1) identified in the sponsor information 230. The following is a non-limiting example of a sponsorship system that may be implemented by the computing system 112.

The computing system 112 may be configured to implement different levels of sponsorship. For example, a sponsor entity may be able to exclusively sponsor a particular sound associated with a brand/product identifier owned or controlled by the sponsor entity. By way of another non-limiting example, a sponsor may non-exclusively sponsor a sound. Further, different costs (or premiums) may be associated with different levels of sponsorship. For example, exclusive sponsorship may be more expensive than non-exclusive sponsorship. Thus, the sponsor entities 140A and 140B (associated with brand/product identifiers) can sponsor sounds (associated with the same brand/product identifiers) at various levels of exclusivity and premiums for placement, impressions, etc.

For example, if the sponsor entity associated with the brand name CREST® wants to be a non-exclusive rank-and-file sponsor (e.g., along with 30 other brands) of the short “E” sound, the sponsorship may cost X dollars. By way of a non-limiting example, this may be a LEVEL 4 sponsorship. If the sponsor entity associated with the brand name CREST® wants to be a “preferred” sponsor of that sound, its brand may appear more often for that sound compared to other brands, and the cost may be higher (or greater than X dollars). By way of a non-limiting example, this may be a LEVEL 3 sponsorship. If the sponsor entity associated with the brand name CREST® wants to be the sole toothpaste sponsor of the short “E” sound, the cost may again be different. By way of a non-limiting example, this may be a LEVEL 2 sponsorship. Continuing with this example, if the sponsor entity associated with the brand name CREST® wants to be the sole toothpaste sponsor for the entire reading system, then the cost may be different yet again. By way of a non-limiting example, this may be a LEVEL 1 sponsorship.

Other pricing structures may be determined by other factors, such as where the sponsored sound (e.g., the short “E” sound) lies within the reading curriculum, and how many times the sound is presented in the curriculum. Further, sponsorship may be in effect for a predetermined duration (e.g., a year). In such embodiments, at the expiration of the sponsorship duration, the sponsor entity may have the option to renew the sponsorship, if desired.

When the computing system 112 encounters more than one brand/product identifier associated with a sound and/or a word identified in one of the books B1-B12, the computing system 112 may use the sponsorship levels associated with the brand/product identifiers to determine (at least in part) which of the brand/product identifiers is displayed to the users 120A-120C.

By way of another non-limiting example, when the computing system 112 encounters more than one brand/product identifier associated with a sound and/or a word identified in one of the books B1-B12, the computing system 112 may use the demographic information associated with the users 120A-120C (in the user information 270) and with the brand/product identifiers (in the brand information 210) to determine (at least in part) which of the brand/product identifiers is displayed to the users 120A-120C.

Further augmenting the model, a rewards program that provides product giveaways and/or coupons for free or reduced priced products may be awarded to the users 120A-120C at various times, such as at lesson completion, book completion, and/or system (curriculum) completion. The sponsorship levels may be associated with the rewards (or giveaways) specified in the reward information 272. For example, a LEVEL 1 sponsorship may indicate that when the curriculum has been completed, those users who completed the curriculum will receive something from each sponsor entity that purchased a LEVEL 1 sponsorship. Further, in some embodiments, those sponsor entities that provide rewards may be eligible for lower cost sponsorship options and/or a reduced sponsorship price.

In some embodiments, the sponsor entities 140A and 140B may be charged sponsorship fees based on how many of the users 120A-120C complete the curriculum. For example, the sponsor entities 140A and 140B may be charged a fee (optionally based at least in part on their respective sponsorship levels) each time one of the users 120A-120C complete the curriculum or a portion thereof (e.g., one of the books B1-B12).

The computing system 112 may be configured to generate metrics and/or statistics viewable by the sponsor entities 140A and 140B. For example, the computing system 112 may generate and transmit a user interface display (not shown) to the sponsor computing systems 142. The user interface display may be customized for each sponsor entity. For example, the user interface display sent to the sponsor computing system 142 operated by the sponsor entity 140A may show how many of the users 120A-120C received displays depicting the brand/product identifier(s) associated with the sponsor entity 140A. By way of another non-limiting example, the user interface display may show how many of the users 120A-120C viewed (and/or completed) the entire curriculum.

In some embodiments, the reading system implemented by the system 100 will be available to users at no cost. In the embodiment illustrated in FIG. 1, the reading system implemented by the computing system 112 may be web-based so that the users 120A-120C may access the reading system using any web-enabled device (e.g., the client computing devices 130A-130C). By utilizing the aforementioned business model, the sponsor entities 140A and 140B (e.g., companies) can help the users 120A-120C learn how to read while simultaneously promoting their brands and/or products. And, the users 120A-120C are provided with a fun, easy, and free way to learn how to read, in contrast to the many tedious and expensive programs currently available. The reading system implemented by the computing system 112 may be especially effective at teaching English in foreign countries where American products are widely known and recognized. Similar reading systems can be used for other languages as well.

Tables A and B above provide several examples of sponsorships for various sounds of the English language. These sponsorship associations are provided as examples for explanatory purposes only.

### Methods

FIG. 10 is a flow diagram of a method 300 performed by the computing system 112. For ease of illustration, the method 300 will be described as being performed by the server 114. Before the method 300 begins, one or more of the users 120A-120C may visit a website implemented at least in part by the server 114. In such embodiments, the server 114 is configured to generate a display (e.g., a webpage) that allows the users 120A-120B to request lessons. The client computing devices 130A-130C are configured to display the display to the users 120A-12C, respectively. Further, each of the client computing devices 130A-130C includes user interface components configured to receive lesson requests. After receiving the user selections, the client computing devices 130A-130C are configured to transmit the lesson requests to the server 114.

In first block 310, the server 114 receives a lesson request from one of the users 120A-120C (via the network 150) for a lesson in one of the books B1-B12 (see FIGS. 3 and 4) stored in the curriculum information 260. For ease of illustration, the request will be described as having been received from the user 120A.

In block 315, the server 114 accesses the curriculum information 260 stored on the data storage device 116 (see FIGS. 1-4), and selects a lesson from the requested book.

In block 320, the server 114 instructs the client computing device 130A to display one of the displays 280, 284, 288, 292, and 296 illustrated in FIGS. 5-9, respectively, depending upon which of the books B1-B12 the user 120A has requested. For example, in block 320, the server 114 may generate the appropriate display, and transmit the display to the computing device 130A over the network 150 (see FIG. 1). In such embodiments, the computing device 130A receives the display, and displays it to the user 120A.

Optionally, the user 120A may indicate that the user 120A has completed the lesson (e.g., by clicking the button “NEXT LESSON” on the display). When the user 120A indicates that the user 120A has completed the lesson, the computing device 130A may send an acknowledgement to the server 114 via the network 150. In optional block 322, the server 114 receives the acknowledgement indicating the user 120A completed the lesson.

In block 325, the server 114 records the lesson as having been completed by the user 120A in the user information 270. Optionally, in block 320, the server 114 may record when the server 114 instructed the client computing device 130A to display the display. In such embodiments, if the server 114 receives the acknowledgement (in optional block 322) in less than a predetermined amount of time after the server 114 instructed the client computing device 130A to display the display, the server 114 may forgo (or skip) recording the lesson as having been completed by the user 120A (in block 325) because the user 120A did not view the lesson long enough to have completed it. Thus, if the server 114 provides rewards to the user 120A based at least in part on the user 120A having completed the lesson, the receipt of the acknowledgement (in optional block 322) will not count toward the reward.

Then, in decision block 330, the server 114 determines whether the user 120A has completed the requested book. The server 114 may make this determination based at least in part on the user information 270. Alternatively, the server 114 may make this determination based only on the curriculum information 260. The decision in decision block 330 is “NO” when the server 114 determines the user 120A has not completed the book. On the other hand, the decision in decision block 330 is “YES” when the server 114 determines the user 120A has completed the book. When the decision in decision block 330 is “NO,” the server 114 advances to decision block 335.

In decision block 335, the server 114 determines whether to send a next lesson to the user 120A. The decision in decision block 335 is “NO” when the server 114 decides not to send the next lesson to the user 120A. On the other hand, the decision in decision block 335 is “YES” when the server 114 decides to send the next lesson to the user 120A. By way of a non-limiting example, the server 114 may decide to send the next lesson to the user 120A when the server 114 receives a lesson request from the user 120A for another lesson (e.g., the server 114 receives the acknowledgement in optional block 322). By way of another non-limiting example, the server 114 may decide to send the next lesson to the user 120A after a predetermined period of time has elapsed since the display was transmitted to the computing device 130A.

When the decision in decision block 335 is “YES,” the server 114 returns to block 315 to select the next lesson. When the decision in decision block 335 is “NO,” the method 300 terminates.

When the decision in decision block 330 is “YES,” the server 114 advances to optional block 340. In optional block 340, the server 114 rewards the user 120A. For example, the server 114 may instruct the computing device 130A to display a notification that the currently selected book has been completed. Optionally, the server 114 may reward the user 120A by sending a notification to one of the sponsor computing systems 142 to send a tangible reward to the user 120A. Which of the sponsor computing systems 142 to notify may be specified in the optional reward information 272 (see FIG. 2). The tangible reward may include a product associated with one or more of the brand/product identifiers stored in the brand information 210. The server 114 may record the reward in the user information 270. Then, the server 114 advances to decision block 345.

In decision block 345, the server 114 determines whether the user 120A has completed the curriculum (e.g., the books B1-B12) stored in the curriculum information 260. The server 114 may make this determination based at least in part on the user information 270. Alternatively, the server 114 may make this determination based only on the curriculum information 260. The decision in decision block 345 is “NO” when the server 114 determines the user 120A has not completed the curriculum. On the other hand, the decision in decision block 345 is “YES” when the server 114 determines the user 120A has completed the curriculum. When the decision in decision block 345 is “NO,” the server 114 returns to decision block 335. When the decision in decision block 345 is “YES,” the server 114 advances to optional block 350.

In optional block 350, the server 114 rewards the user 120A. For example, the server 114 may instruct the computing device 130A to display a notification that the curriculum has been completed. Optionally, the server 114 may reward the user 120A by sending a notification to one of the sponsor computing systems 142 to send a tangible reward to the user 120A. Which of the sponsor computing systems 142 to notify may be specified in the optional reward information 272 (see FIG. 2). The tangible reward may include a product associated with one or more of the brand/product identifiers stored in the brand information 210. The server 114 may record the reward in the user information 270. Then, the method 300 terminates.

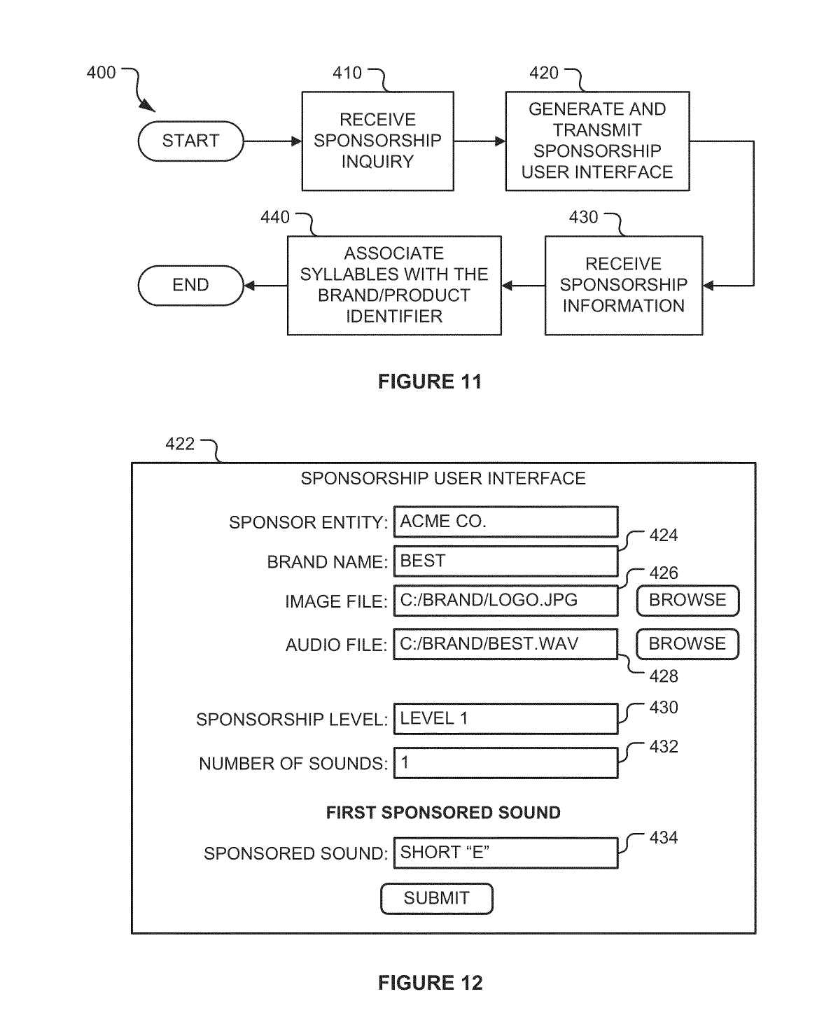

FIG. 11 is a flow diagram of a method 400 performed by the computing system 112. For ease of illustration, the method 400 will be described as being performed by the server 114. The method 400 allows the sponsor entities 140A and 140B to sponsor at least one sound at a selected sponsorship level. Before the method 400 begins, one or more of the sponsor entities 140A and 140B may visit a website implemented at least in part by the server 114, and submit a sponsorship inquiry to the server 114.

In first block 410, the server 114 receives the sponsorship inquiry from the sponsor computing system 142 operated by one of the sponsor entities 140A and 140B (via the network 150). For ease of illustration, the inquiry will be described as having been received from the sponsor computing system 142 operated by the sponsor entity 140A.

In next block 420, the server 114 instructs the sponsor computing system 142 operated by the sponsor entity 140A to display a sponsorship user interface. For example, in block 420, the server 114 may generate a sponsorship user interface (e.g., a webpage) and transmit the sponsorship user interface to the sponsor computing system 142 operated by the sponsor entity 140A (via the network 150). The sponsor computing system 142 is configured to display the sponsorship user interface and receive sponsorship information entered into the interface by the sponsor entity 140A.

An exemplary sponsorship user interface 422 is illustrated in FIG. 12. The sponsorship user interface 422 includes user inputs 424-434. The sponsor entity 140A enters the brand name (e.g., the text “BEST”) into the user input 424. The sponsor entity 140A uses the user input 426 to select an image file (e.g., a logo, product photograph, illustration, and the like) associated with the brand name for upload to the server 114. If an image is selected, the image functions as the brand/product identifier. On the other hand, if an image is not selected, the brand name functions as the brand/product identifier. The sponsor entity 140A uses the user input 428 to select an audio file (in which the brand name is pronounced) for upload to the computing system 112, which may provide the audio file to the users 120A-120C. The sponsor entity 140A uses the user input 430 to select a sponsorship level (e.g., LEVEL 1). The sponsor entity 140A uses the user input 432 to specify how many sounds are included in the brand name (e.g., one). For each sound, the sponsorship user interface 422 includes a different user input 434. The sponsor entity 140A uses each user input 434 to specify a different sound (e.g., “Short ‘E’” sound) associated with the brand name. After the sponsor entity 140A has used the user inputs 424-434 to input the sponsorship information, the sponsor entity 140A submits the information to the server 114.

Optionally, the sponsorship user interface 422 may allow the sponsor entity 140A to enter payment information for adding the brand/product identifier to the brand information 210 (see FIG. 2) used by the computing system 212 (see FIG. 1). Alternatively, the server 114 may send payment information (e.g., over the network 150, via the mail, etc.) to the sponsor entity 140A. In some embodiments, the sponsor entity 140A may receive an invoice from the computing system 112 periodically (e.g., monthly). The invoice may include fees based at least in part on how many times the brand/product identifier was displayed to a user.

Optionally, the sponsorship user interface 422 may allow the sponsor entity 140A to enter (or specify) user demographic information (e.g., geographic region, gender, age, ethnicity, nationality, religion, language, education, income, preferences, and the like) indicating which types of users are more likely to purchase products or services associated with the brand/product identifier.

In block 430, the server 114 receives the sponsorship information and stores it on the data storage device 116 (see FIG. 1).

In block 440, the server 114 associates a syllable of each of at least a portion of the vocabulary words with the brand/product identifier received in block 430.

Then, the method 400 terminates.

### Computing Device

FIG. 13 is a diagram of hardware and an operating environment in conjunction with which implementations of the one or more computing devices of the system 100 may be practiced. The description of FIG. 13 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 13 includes a general-purpose computing device in the form of the computing device 12. Each of the computing devices of FIG. 1 (including the server 114) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface. The user interface is operable to display the displays 280, 284, 288, 292, and 296 illustrated in FIGS. 4-9, respectively, and the sponsorship user interface 422 illustrated in FIG. 12. The user interface is further operable to receive the sponsorship information input into the sponsorship user interface 422, and receive lesson requests to be transmitted to and received by the server 114 (see FIG. 1).

Returning to FIG. 13, the computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 13 include a local-area network (LAN) 51 and a wide-area network (WAN) 52. Such networking environments are commonplace in offices, enterprise-wide computer networks, intranets and the Internet. The network 150 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 300 and 400 illustrated in FIGS. 10 and 11, respectively) described above. Such instructions may be stored on one or more non-transitory computer-readable media.

In some embodiments, the system memory 22 stores computer executable instructions that when executed by one or more processors cause the one or more processors to generate the displays 280, 284, 288, 292, and 296 illustrated in FIGS. 4-9, respectively, and the sponsorship user interface 422 illustrated in FIG. 12. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer implemented method for use with a client computing device operated by a user, the client computing device being connected to a server computing device by at least one network, the server computing device being connected to or including a data storage device, the method comprising:
associating, in the data storage device, an identifier of a brand or product with a particular sound in a selected language, the identifier having been promoted to an audience by a sponsor entity associated with the brand or product, the audience comprising the user, the identifier being well known to the audience as a result of the promotion, the brand or product having a name comprising the particular sound in the selected language;
receiving, by the server computing device, a request for a lesson from the client computing device, the lesson being configured to help teach the user to read one or more letters spelling at least one of (a) the particular sound in the selected language, and (b) a word comprising the particular sound in the selected language;
in response to the request, transmitting, by the server computing device, instructions configured to instruct the client computing device to display a display to the user, the display comprising (a) the one or more letters, and (b) the identifier of the brand or product; and
recording completion of the lesson.

2. The method of claim 1, wherein the audience comprises the general public.

3. The method of claim 1 for use with the server computing device being operated by a teaching entity, wherein the sponsor entity is different from the teaching entity.

4. The method of claim 3, wherein the teaching entity received at least one payment from the sponsor entity in exchange for associating the identifier with the particular sound in the data storage device.

5. The method of claim 3, wherein the teaching entity charges the sponsor entity an amount of money for transmitting the display.

6. The method of claim 3, further comprising:
sending, by the server computing device, an invoice to the sponsor entity.

7. The method of claim 6, wherein the invoice comprises a fee based at least in part on the display having been transmitted.

8. The method of claim 1, wherein the display further comprises at least one of (a) an audio file, and (b) a link to the audio file; and
when the audio file is played back, the audio file pronounces the particular sound.

9. The method of claim 1 for use with the server computing device being operated by a teaching entity, and the sponsor entity operating a sponsor computing system connected to the server computing device, wherein the sponsor entity is different from the teaching entity, and
the method further comprises transmitting a request to the sponsor computing system requesting that a reward be sent to the user operating the client computing device.

10. The method of claim 9, wherein the reward is associated with the identifier of the brand or product.

11. The method of claim 1, wherein the identifier is a trademark or a logo.

12. The method of claim 1, wherein the particular sound is a vowel sound and the selected language is English.

13. A computer implemented method for use with a client computing device operated by a user, the client computing device being connected to a server computing device by at least one network, the server computing device being connected to or including a data storage device, the method comprising:
associating, in the data storage device, a plurality of identifiers with a plurality of sounds in a selected language, the plurality of identifiers being well known to an audience comprising the user as a result of advertising, each of the plurality of identifiers being associated with a brand name, each sound associated with one of the identifiers being included in the brand name also associated with the identifier;
selecting, by the server computing device, one of the plurality of sounds; and
transmitting, by the server computing device, instructions configured to instruct the client computing device to display a display to the user, the display comprising (a) one or more letters spelling the selected sound in the selected language, and (b) at least one of the identifiers associated with the selected sound.

14. The method of claim 13, wherein the audience comprises the general public.

15. The method of claim 13, wherein the selected sound is a first selected sound, the display is a first display, and the method further comprises:
selecting, by the server computing device, one of the plurality of sounds as a second selected sound, the second selected sound being different from the first selected sound; and
transmitting, by the server computing device, instructions configured to instruct the client computing device to display a second display to the user, the second display comprising (a) one or more letters spelling the second selected sound in the selected language, and (b) at least one of the identifiers associated with the second selected sound.

16. The method of claim 13, wherein the selected sound is a first selected sound, the display is a first display, and the method further comprises:
selecting, by the server computing device, one of the plurality of sounds as a second selected sound, the second selected sound being different from the first selected sound; and
transmitting, by the server computing device, instructions configured to instruct the client computing device to display a second display to the user, the second display comprising (a) one or more letters spelling a vocabulary word in the selected language that includes the second selected sound, and (b) at least one of the identifiers associated with the second selected sound.

17. The method of claim 13, wherein the display is a first display, and the method further comprises:
selecting, by the server computing device, a vocabulary word comprising the selected sound; and
transmitting, by the server computing device, instructions configured to instruct the client computing device to display a second display to the user, the second display comprising (a) one or more letters spelling the vocabulary word, and (b) at least one of the identifiers associated with the second selected sound.

18. The method of claim 13, wherein each of the plurality of identifiers is associated with a sponsorship level, and the method further comprises:
selecting, by the server computing device, the at least one of the identifiers associated with the selected sound based at least in part on the sponsorship level associated with each of the identifiers associated with the selected sound.

19. The method of claim 13, wherein each of the plurality of identifiers is associated with first demographic information, and the method further comprises:
associating, in the data storage device, the user with second demographic information; and
selecting, by the server computing device, the at least one of the identifiers associated with the selected sound based at least in part on the second demographic information and the first demographic information associated with each of the identifiers associated with the selected sound.

20. The method of claim 13, further comprising:
associating, in the data storage device, each of the plurality of identifiers with a sponsorship level; and
selecting, by the server computing device, the at least one of the identifiers associated with the selected sound based at least in part on the sponsorship level associated with each of the identifiers associated with the selected sound.

21. A system for use with a plurality of client computing devices operated by a plurality of users, the system comprising:
a data storage device storing a plurality of identifiers associated with a plurality of sounds in a selected language, the plurality of identifiers being well known to an audience comprising the plurality of users as a result of advertising, each of the plurality of identifiers being associated with a brand name, each sound associated with one of the identifiers being included in the brand name also associated with the identifier; and
a server computing device connected to both the data storage device, and the plurality of client computing devices, the server computing device being configured to execute computer executable instructions that when executed perform a method comprising:
receiving a plurality of lesson requests, a different lesson request having been received from each the plurality of client computing devices, and
in response to each of the plurality of lesson requests, selecting one of the plurality of sounds as a selected sound, and transmitting a display to the client computing device from which the lesson request was received, the display comprising at least one of the identifiers associated with the selected sound, and one or more letters spelling at least one of (a) the selected sound in the selected language, and (b) a vocabulary word in the selected language that includes the selected sound.

22. The system of claim 21 for use with a sponsor computing system connected to the server computing device, the sponsor computing system being operated by a sponsor entity, wherein each of at least a portion of the plurality of identifiers is associated with the sponsor entity in the data storage device, each identifier associated with the sponsor entity being a sponsored identifier,
for a particular one of the lesson requests, the at least one of the identifiers associated with the selected sound comprises at least one sponsored identifier, and
the method further comprises transmitting usage information to the sponsor computing system, the usage information indicating that the display including the at least one sponsored identifier was transmitted.

23. The system of claim 21 for use with a sponsor computing system connected to the server computing device, the sponsor computing system being operated by a sponsor entity, wherein each of at least a portion of the plurality of identifiers is associated with the sponsor entity in the data storage device, each identifier associated with the sponsor entity being a sponsored identifier,
for a particular one of the lesson requests, the at least one of the identifiers associated with the selected sound comprise at least one sponsored identifier, and
the method further comprises transmitting an invoice to the sponsor computing system, the invoice including a fee based at least in part on the display including the at least one sponsored identifier having been transmitted.

24. The system of claim 21, wherein the plurality of identifiers is associated with a plurality of sponsor entities in the data storage device, and the method further comprises:
periodically sending invoices to the plurality of sponsor entities; and
receiving payments from the plurality of sponsor entities in response to the invoices.

25. The system of claim 21, wherein each of the plurality of identifiers is associated with a sponsorship level in the data storage device, and
the method further comprises, in response to each of the plurality of lesson requests, selecting the at least one of the identifiers associated with the selected sound included in the display based at least in part on the sponsorship level associated with each of the plurality of identifiers associated with the selected sound.

26. The system of claim 21 for use with each of the plurality of users being associated with first demographic information, wherein each of the plurality of identifiers is associated with second demographic information in the data storage device, and
the method further comprises, in response to each of the plurality of lesson requests, selecting the at least one of the identifiers associated with the selected sound included in the display based at least in part on (a) the second demographic information associated with each of the plurality of identifiers associated with the selected sound, and (b) the first demographic information associated with the user of the client computing device from which the lesson request was received.
